(19) United States
(12) Patent Application Publication
(10) Pub. No.: US 2014/0129241 A1
(43) Pub. Date: May 8, 2014

(54) Systems and Methods for Generating Healthcare Intelligence

(71) Applicant: BROAD JUMP LLC, Plano, TX (US)

(72) Inventors: David Carl Ricker, Plano, TX (US); Daniel Ross DeTorrice, Wylie, TX (US); David Lawrence Hixon, Frisco, TX (US)

(73) Assignee: BROAD JUMP LLC, Plano, TX (US)

(21) Appl. No.: 13/672,415

(22) Filed: Nov. 8, 2012

(51) Int. Cl. G06Q 50/22

(52) U.S. Cl. CPC G06Q 50/22; G06Q 10/0635
USPC 705/2

(57) ABSTRACT

A method includes a first healthcare provider purchasing a first offering for a first offering first price and a second offering for a second offering first price, a second healthcare provider purchasing the first offering for a first offering second price and the second offering for a second offering second price, and presenting at least one of (1) an indication configured to allow a comparison of a first sum of the first offering first price and the second offering first price versus a second sum of the first offering second price and the second offering second price and (2) an indication presented as a result of a comparison of the first sum versus the second sum.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In some industries, such as, but not limited to, the healthcare industry, prices for goods and/or services may be negotiated under circumstances that substantially prevent some parties from making adequately informed market decisions. For example, in the healthcare industry, healthcare offering suppliers may offer goods and/or services at retail prices as well as at discounted prices. In some cases, the discounted prices may be made available to healthcare providers that enter into agreements with a group purchasing organization or group purchasing cooperative. The group purchasing organization may negotiate with multiple healthcare offering suppliers and multiple healthcare providers to provide healthcare offerings of a particular type or offering category to participating healthcare providers at prices in accordance with a price list. The price list may encompass pricing and/or volume expectations related to a plurality of offerings in an offering category. In some cases, a determination by a healthcare provider of whether participation with the group purchasing organization would be beneficial to a particular healthcare provider may most reliably be evaluated by comparing the prices currently paid by the healthcare provider for the offerings it purchases to the prices the healthcare provider would pay under an agreement that utilizes the price list. While this comparison may be effective for determining relative value of participating in one group purchasing organization versus another group purchasing organization, the comparison does not account for other significant market factors and/or behaviors. More specifically, in some cases, even though a healthcare provider may be contractually obligated to purchase offerings of a particular offering category in accordance with a particular price list, it is not uncommon for parties to subvert or otherwise not comply with the price list by at least one of providing offerings at discounts, offering monetary rewards, providing offerings for free, and/or otherwise transferring ownership of offerings to the healthcare providers, at least as the offerings of the price list are considered in aggregate, at a cost less than that prescribed by the price list.

### SUMMARY

In some embodiments of the disclosure, a method is provided that comprises receiving a first set of first category data of a first healthcare provider, the first set of first category data comprising (1) offering identification data associated with a plurality of offerings of the first healthcare provider and (2) offering price data associated with the plurality of offerings of the first healthcare provider; receiving a second set of first category data of a second healthcare provider, the second set of first category data comprising (1) offering identification data associated with a plurality of offerings of the second healthcare provider and (2) offering price data associated with the plurality of offerings of the second healthcare provider; comparing the plurality of offerings of the second healthcare provider to the plurality of offerings of the first healthcare provider; determining whether a predetermined criteria is met regarding whether a sufficient commonality exists between the plurality of offerings of the second healthcare provider and the plurality of offerings of the first healthcare provider; and when the predetermined criteria is met, presenting at least one of (1) an indication configured to allow a comparison of a first sum of the first offering price associated with the first offering from the first healthcare provider and the first offering price associated with the second offering from the first healthcare provider versus a second sum of the second offering price associated with the first offering from the second healthcare provider and the second offering price associated with the second offering from the second healthcare provider and (2) an indication presented as a result of a comparison of the first sum versus the second sum.

In other embodiments of the disclosure, a method is provided that comprises defining a first offering category comprising a first offering and a second offering; receiving a first offering price associated with the first offering from a first healthcare provider; receiving a first offering price associated with the second offering from the first healthcare provider; receiving a second offering price associated with the first offering from a second healthcare provider; receiving a second offering price associated with the second offering from the second healthcare provider; and presenting at least one of (1) an indication configured to allow a comparison of a first sum of the first offering price associated with the first offering from the first healthcare provider and the first offering price associated with the second offering from the first healthcare provider versus a second sum of the second offering price associated with the first offering from the second healthcare provider and the second offering price associated with the second offering from the second healthcare provider and (2) an indication presented as a result of a comparison of the first sum versus the second sum.

In yet other embodiments of the disclosure, a method is provided that comprises a first healthcare provider purchasing a first offering for a first offering first price and a second offering for a second offering first price, a second healthcare provider purchasing the first offering for a first offering second price and the second offering for a second offering second price, and presenting at least one of (1) an indication configured to allow a comparison of a first sum of the first offering first price and the second offering first price versus a second sum of the first offering second price and the second offering second price and (2) an indication presented as a result of a comparison of the first sum versus the second sum.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a schematic view of a healthcare industry according to an embodiment of the disclosure;

FIG. 2 is a schematic view of a healthcare offering supplier (HOS) of the healthcare industry of FIG. 1;

FIG. 3 is a schematic view of a healthcare provider (HP) of the healthcare industry of FIG. 1;

FIG. 4 is a schematic view of a healthcare intelligence provider (HIP) of the healthcare industry of FIG. 1;

FIG. 5 is a flowchart of a method of generating healthcare intelligence according to an embodiment of the disclosure;

FIG. 6 is a flowchart of a method of generating healthcare intelligence according to another embodiment of the disclosure;

FIG. 7 is a table of healthcare provider data according to an embodiment of the disclosure;

FIG. 8 is a flowchart of a method of generating healthcare intelligence according to an embodiment of the disclosure;

FIG. 9 is a scatterplot generated as a function of the method of FIG. 8; and

FIG. 10 is a representation of a general-purpose processor (e.g., electronic controller or computer) system, one or more of which are suitable for implementing the embodiments of the disclosure.

### DETAILED DESCRIPTION

In some cases, it may be desirable to provide systems and methods that enable a healthcare provider to make better informed decisions prior to entering into agreements to purchase healthcare related offerings. More specifically, in view of the great variance that healthcare providers may actually pay for the same offerings, even amongst healthcare providers that are parties to the same and/or similar group purchasing organization price lists for a particular offering category, it may be desirable to provide the healthcare providers with healthcare intelligence that is related to the above-described differences in the amounts actually and/or effectively paid for offerings. In some embodiments, systems and methods are provided that may inform a healthcare provider of what other similarly situated healthcare providers have actually paid and/or effectively paid for the same and/or similar offerings. In some embodiments, systems and methods are provided that may generate a price list as a function of information gathered from two or more healthcare providers.

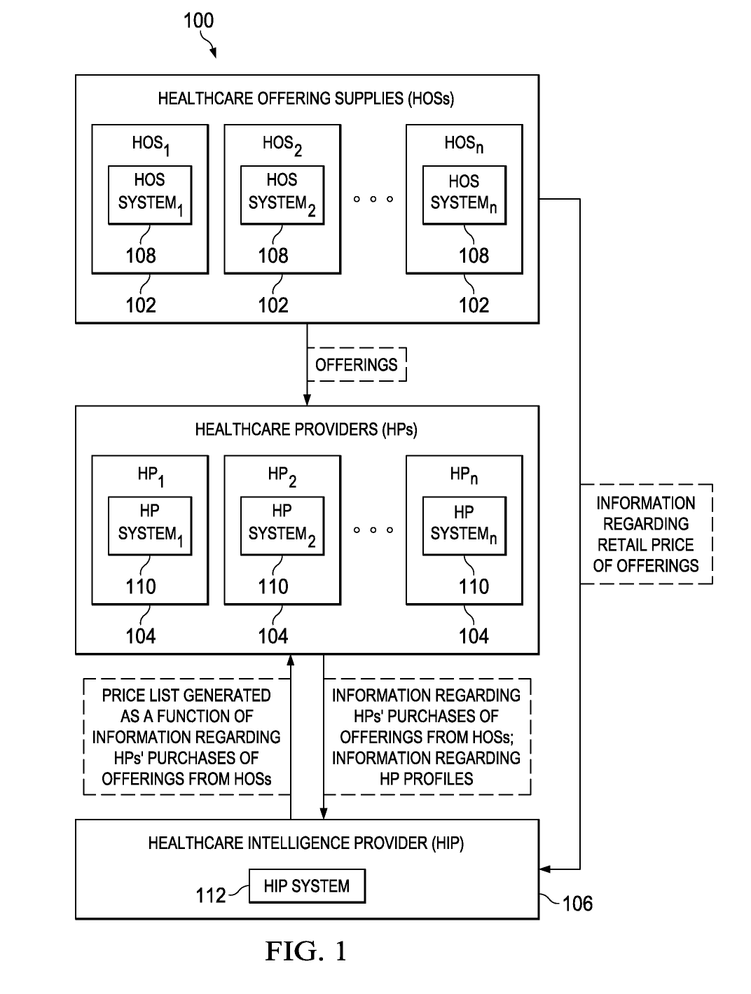

Referring now to FIG. 1, a schematic diagram of a healthcare industry 100 according to an embodiment of the disclosure is shown. The healthcare industry comprises a plurality of healthcare offering suppliers (HOSs) 102, a plurality of healthcare providers (HPs) 104, and a healthcare intelligence provider (HIP) 106. Each HOS 102 comprises an HOS system 108, each HP 104 comprises an HP system 110, and the HIP 106 comprises an HIP system 112. In some cases, the HOSs 102 are producers, distributors, suppliers, and/or the like that selectively provide healthcare related offerings, such as, but not limited to, healthcare related goods, products, services, and/or the like to the HPs 104. In some cases, the HPs 104 comprise hospitals, hospital systems, surgery centers, medical rehabilitation centers, assisted living facilities, nursing homes, hospice facilities, and/or the like. In some cases, the HIP 106 is configured to selectively collect healthcare intelligence from the HOSs 102 and/or HPs 104 and/or to generate and/or disseminate healthcare intelligence to the HOSs 102 and/or HPs 104. In some embodiments, the healthcare intelligence collected may comprise information regarding HPs' 104 purchases of offerings from HOSs 102 and/or information regarding HP 104 profiles. The information regarding HPs' 104 purchases of offerings from HOSs 102 may comprise information such as, but not limited to, prices of offerings (actual prices paid for offerings and/or agreed upon prices for offerings), volume of offerings (actual volumes of offerings purchased and/or agreed upon purchase volumes), and/or any other information related to the exchange of valuable consideration and/or offerings between the HOSs 102 and the HPs 104.

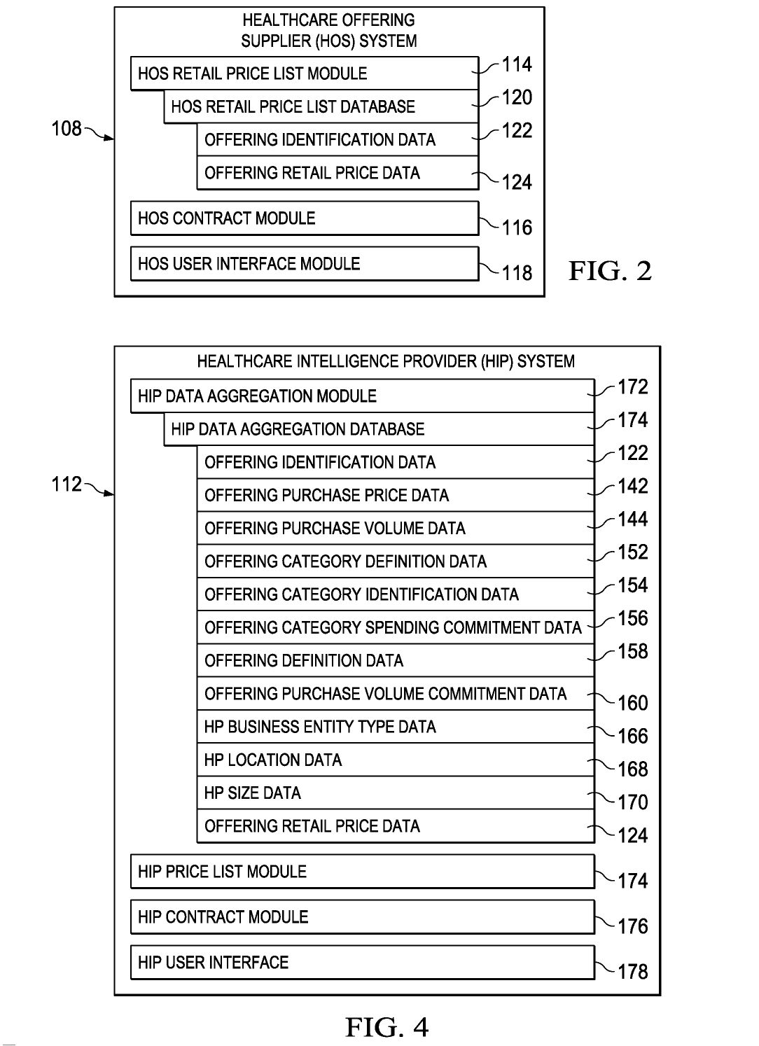

Referring now to FIG. 2, a schematic diagram of an HOS system 108 is shown. In some embodiments, an HOS system 108 comprises an HOS retail price list module 114, an HOS contract module 116, and an HOS user interface module 118. The HOS retail price list module 114 may comprise an HOS retail price list database 120 comprising offering identification (ID) data 122 and offering retail price data 124. The offering identification data 122 may comprise any information related to identifying offerings, recognizing offerings, and/or distinguishing different offerings from each other. The offering retail price data 124 may comprise any information related to prices at which the HOSs 102 may generally sell offerings to HPs 104 without special market arrangements, such as, but not limited to, according to a price list associated with a group purchasing organization or the like.

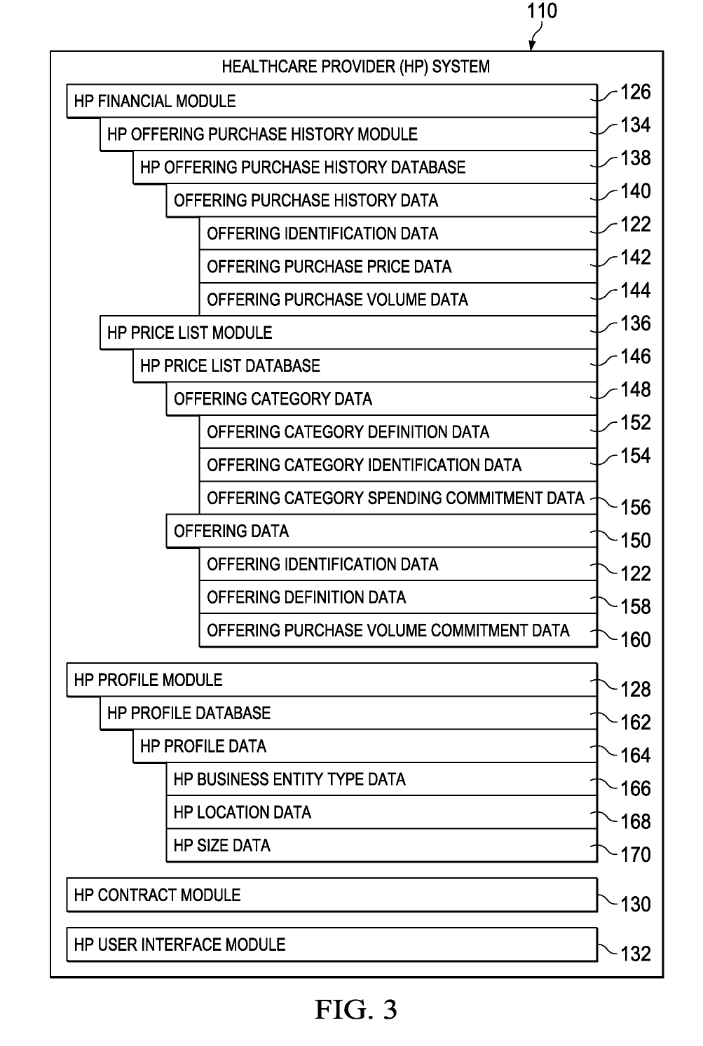

Referring now to FIG. 3, a schematic diagram of an HP system 110 is shown. In some embodiments, an HP system 110 may comprise an HP financial module 126, an HP profile module 128, an HP contract module 130, and an HP user interface module 132. The HP financial module 126 may comprise an HP offering purchase history module 134 and an HP price list module 136. The HP offering purchase history module 134 may comprise an HP offering purchase history database 138. The HP offering purchase history database 138 may comprise offering purchase history data 140 such as, but not limited to, offering identification data 122, offering purchase price data 142, and offering purchase volume data 144. The HP price list module 136 may comprise an HP price list database 146 comprising offering category data 148 and offering data 150. The offering category data 148 may comprise information related to categorizing offerings, such as, but not limited to, offering category definition data 152, offering category identification (ID) data 154, and offering category spending commitment data 156. The offering data 150 may comprise any information related to offerings, such as, but not limited to, offering identification data 122, offering definition data 158, and offering purchase volume commitment data 160. The HP profile module 128 may comprise an HP profile database 162 comprising HP profile data 164. The HP profile data 164 may comprise any information related to classifying, categorizing, and/or comparing HPs 104, such as, but not limited to, HP business entity type data 166, HP location data 168, and HP size data 170.

Referring now to FIG. 4, a schematic diagram of an HIP system 112 is shown. In some embodiments, an HIP system 112 comprises an HIP data aggregation module 172, an HIP price list module 174, an HIP contract module 176, and an HIP user interface 178. The HIP data aggregation module 172 may comprise an HIP data aggregation database 180. The HIP data aggregation database 180 may comprise offering identification data 122, offering purchase price data 142, offering purchase volume data 144, offering category definition data 152, offering category identification data 154, offering category spending commitment data 156, offering definition data 158, offering purchase volume commitment data 160, HP business entity type data 166, HP location data 168, HP size data 170, and offering retail price data 124.

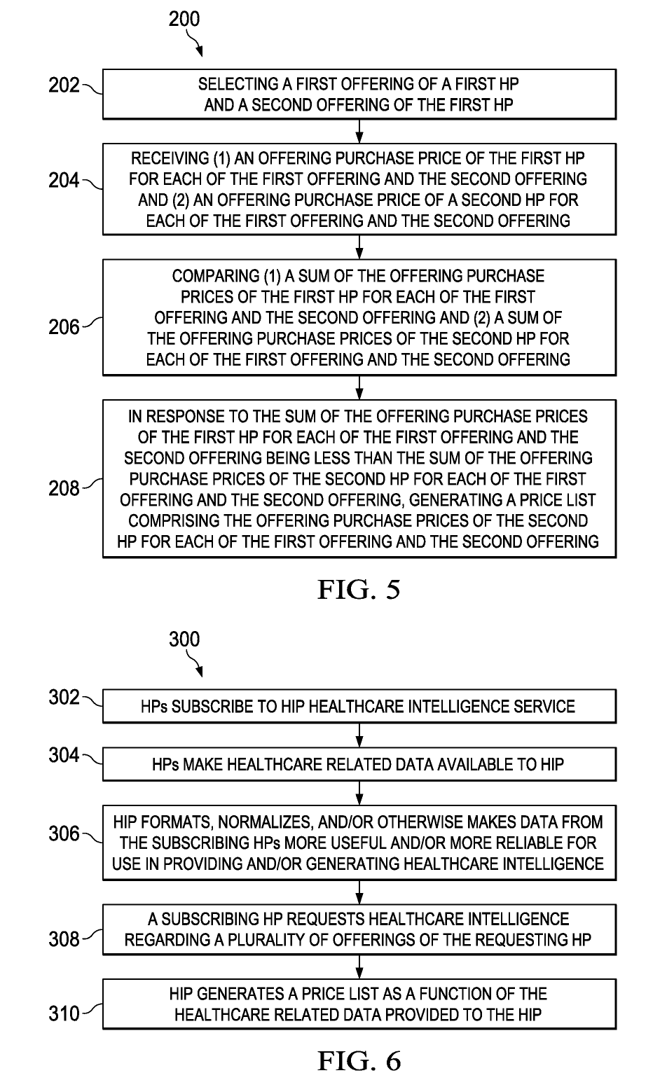

Referring now to FIG. 5, a flowchart of a method 200 of generating healthcare intelligence according to an embodiment of the disclosure. The method 200 may begin at block 202 by selecting a first offering of a first HP and a second offering of the first HP. In some embodiments, the first offering and the second offering may each be suitably described as belonging to a first category. In some embodiments, the selecting may comprise utilizing the HIP data aggregation module 172 to receive offering identification data 122 from the HP offering purchase history databases 138 of the first HP and the second HP and store the received offering identification data 122 in the HIP data aggregation database 180.

The method 200 may progress to block 204 where the HIP data aggregation module 172 may receive offering purchase price data 142 for each of the first offering and the second offering from the first HP and offering purchase price data 142 for each of the first offering and second offering from the second HP. The offering purchase price data 142 may be received from the HP offering purchase history databases 138 of the first HP and the second HP and stored in the HIP data aggregation database 180.

The method 200 may progress to block 206 where the HIP price list module 174 may compare (1) a sum of offering purchase prices of the first HP for each of the first offering and the second offering and (2) a sum of the offering purchase prices of the second HP for each of the first offering and the second offering.

The method 200 may progress to block 208 where, in response to the sum of the offering purchase prices of the first HP for each of the first offering and the second offering being less than the sum of the offering purchase prices of the second HP for each of the first offering and the second offering, the HIP price list module 174 may generate a price list comprising the offering purchase prices of the second HP for each of the first offering and the second offering. In some embodiments, the price list generated by the HIP price list module 174 may be communicated to the first HP.

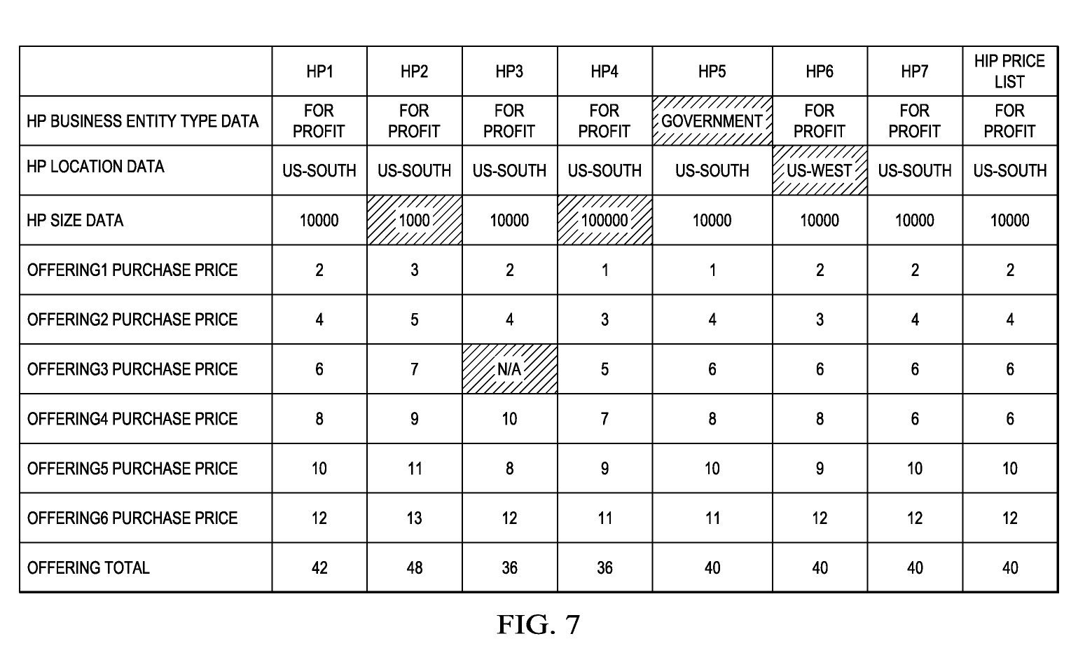

Referring now to FIGS. 6 and 7, a flowchart of a method 300 of generating healthcare intelligence according to another embodiment of the disclosure and an associated table of illustrative data values are shown, respectively. The method 300 may generally be described as a method of enabling an HP 104, HP1, to receive healthcare intelligence that may be generated as a function of both data of HP1 and data of other HPs 104, namely, HP2, HP3, HP4, HP5, HP6, and HP7. In some embodiments, the healthcare intelligence may comprise data from one or more of the HP offering purchase history databases 138, HP price list databases 146, and the HP profile databases 162 of the other HPs 104. In some embodiments, the healthcare intelligence may further comprise data from the HOS retail price list databases of one or more HOSs 102. Accordingly, the method 300 may generally be described as providing and HP 104, such as HP1, with data of other HPs 104 that HP1 would not normally have access to. In some cases, and in the illustrative example discussed below, HP1 may comprise a hospital that may be a participant in a group purchasing organization so that HP1 may be allowed and/or obligated to purchase offerings of a particular category of offerings (goods and/or services) from particular HOSs 102, in a particular volume, for a particular period of time, and/or for a particular price. The participation with the group purchasing organization may be formalized through contractual obligations between HP1, a group purchasing organization, and the HOSs 102. In some embodiments, the contractual obligations may be housed in a database such as HP price list database 146 and the HP price list database 146 of an HP 104 may be substantially similar to the HP price list database of another HP 104 when both HPs 104 participate in the same group purchasing organization for the same category of offerings. In some embodiments, one or more HOSs 102 may similarly subscribe to the services of the HIP 106.

As previously discussed, because some HPs 104 may not strictly abide by the contractual obligations and/or wherein the group purchasing organizations and/or HOSs 102 are allowed to alter the market impact of the participation though the use of rebates, provision of free offerings, and/or other valuable consideration not specified in the contractual obligations, HP1 may not know a degree to which HP1 may be overpaying for offerings as compared to other similarly situated HPs 104. Because the same comparative uncertainty applies to substantially all HPs 104, HP1, HP2, HP3, HP4, HP5, HP6, and HP7 may subscribe to a healthcare intelligence service offered by a HIP 106 as represented at block 302. In some cases, the subscribing may comprise the HPs 104 utilizing the HIP user interface 178 to establish an account with the HIP 106 and otherwise initiate a data sharing relationship between the HPs 104 and the HIP 106. In some embodiments, the HPs 104 subscribing may additionally comprise HPs 104 that are not participating in a group purchasing organization. In still other embodiments, the HPs 104 subscribing may comprise no HPs 104 that are participating in a group purchasing organization.

In some embodiments, the method 300 may continue at block 304 where HP1-HP7 make healthcare related data available to the HIP 106. In some cases, the provision of healthcare related data from the HPs 104 to the HIP 106 may be a requirement for successful subscription to selectively receive healthcare intelligence from the HIP 106. In some cases, the healthcare related data provided to the HIP 106 may comprise. In some embodiments, HOSs 102 may provide data to the HIP 106. In some cases, the HOSs 102 may provide data of the HOS retail price list database 120 to the HIP 106. In some cases, the data made available to the HIP 106 may be received and/or retrieved by the HIP data aggregation module 172 and/or stored in the HIP data aggregation database 180.

The method 300 may continue at block 306 where the HIP price list module 174 may manipulate, transform, and/or organize the data of the HIP data aggregation database 180. In some embodiments, the HIP price list module 174 may attempt, through rules-based artificial intelligence and/or in response to human and/or manual input, to review/ascertain data quality, map data fields to standard data templates, recognize offerings, recognize HPs 104, recognize HOSs 102, recognize and/or assign offering categories, generate peer groups and/or allow for grouping of HPs based on HP profile data 164 in a manner consistent with increasing accuracy of the healthcare intelligence to be generated and/or provided. In some cases, the data received by the HIP 106 may initially be improved by an automated process that may discard spurious and/or decidedly inaccurate data while also allowing an opportunity for a user to manually decide on whether to use, discard, and/or change data that was not previously automatically verified as sufficiently trustworthy for use in generating the healthcare intelligence that is to be provided to subscribing HPs 104 and/or HOSs 102.

The method 300 may continue at block 308 where an HP 104 such as HP1 requests healthcare intelligence from the HIP 106. Because HP1, in most cases, has access to its own data, the healthcare intelligence, in most embodiments, is generated as a function of the data provided by the other HPs 104 and/or HOSs 102. In some embodiments, the healthcare intelligence may directly comprise data provided by the other HPs 104 and/or HOSs 102. In some embodiments, HP1 may request healthcare intelligence as a function of its own HP profile data 164, data of its own HP price list database 146, and/or data of its own HP offering purchase history data 140. In some cases, HP1 may request healthcare intelligence that elucidates how much HP1 pays for an offering or category of offerings as compared to other HPs 104 that comprise similar HP profile data 164. Of course, in some embodiments, HP1 may be free to compare its own data to other HPs 104 that are not substantially similar in HP profile and/or that do not comprise substantially similar data amongst their HP price list database 146. As such, HP1 may be able to ascertain the impacts that differences in HP profiles and/or HP price lists may have on offering purchase price data 142. In some cases, to the extent that such variations in offering purchase price data 142 amongst HP1's offering purchase price data 142 and other HPs 104 is not reasonably explained as a known market function in response to differences in HP profiles, volume and/or spending commitments, or the like, HP1 may determine that the current purchase arrangements it has for offerings is unsatisfactory. It will be appreciate that any number or types of reports, charts, graphs, indexes, specialized benchmark values, and/or the like may be utilized to present the healthcare intelligence to an HP 104 such as HP1.

In some embodiments, the method 300 may progress to block 310 where the HIP 106 may generate a price list as a function of the healthcare related data provided to the HIP from HPs 104 and/or HOSs 102. In some cases, the HIP price list module 174 may determine which HPs 104 are sufficiently similar to HP1 for a reasonable comparison to HP1 and/or may determine which HPs 104 comprise offering purchase history data 140 sufficiently similar in offering identification data 122 overlap so that a reasonable comparison may be made to HP1. Of course, the degree to which a sufficient similarity may be found may comprise logical rules and/or manual user inputs that may be selectively controlled by HP1 and/or HIP 106. In some cases, a greater similarity in HP profiles and greater overlap in offering identification data 122 may generally result in generating more useful healthcare intelligence. In some cases, a price list may be generated that comprises the offering identifications common to HP1 and an HP 104 comprising a sufficient profile similarity to HP1 as well as comprising a lowest sum of offering purchase prices associated with the offering identifications common to the HP1. In some embodiments, the HIP 106 may utilize the HIP contract module 176 to communicate the price list to the HP contract module 130 and/or the HOS contract module 116. With HP1 having gained knowledge that a similarly situated HP 104 is paying for offerings according to the price list generated by the HIP 106, HP1 may then, armed with healthcare intelligence not previously available, attempt to negotiate better pricing for the offerings it purchases from HOSs 102.

Referring now to FIG. 7, for purposes of illustrating an example of the application of the method 300, a table is provided that comprises data received by HIP data aggregation module 172 for each of HP1-HP7. More specifically, each of HP1-HP7 is shown as comprising data for each of HP business entity type data, HP location data, HP size data, and unique offerings, offerings1-offering7. In this embodiment, offering1-offering7 are deemed to be of a shared offering category so that the listing of offering1-offering7 may be considered the offerings of an offering category price list of each HP 104. In this example, HP1 is a hospital that is interested in determining whether another HP 104 is paying a more favorable rate for the offerings of the price list of HP1. A simple way of determining the answer may be to simply compare the offering totals of the HPs 104, however, in some cases, it may be required that a determination be made regarding whether HP1 is sufficiently similar to the other HPs 104. In some cases, if a sufficiently similarity does not exist, it may be assumed that HOSs 102 may not be as inclined to sell offerings to HP1 for the same price. HP2 may be disregarded as a good comparison because of the tenfold size difference between HP2 and HP1, with HP1 being ten times larger than HP2. In some cases, it may be a good market assumption to expect the cost of offerings to smaller HP2 to be greater than that of HP1. HP4 may be disregarded as a good comparison because of the tenfold size difference between HP4 and HP1, with HP4 being ten times larger than HP1. In some cases, it may be a good market assumption to expect the cost of offerings to smaller HP1 to be greater than that of HP4. HP5 and HP6 may be disregarded as good comparisons because they do not match HP1 in HP business entity type and HP location, respectively. The remaining HPs 104 for consideration may be HP3 and HP7, each of which are sufficiently similar in HP profile to HP1. However, in some cases, a minimum percentage of overlap in offerings may be required as a determinant of whether an HP 104 is a good comparison to HP1. In this example, the minimum overlap percentage is established at 90%. While HP7 comprises 100% offering overlap with HP1, HP3 only comprises about an 83% offering overlap because HP3 does not purchase offering3, thereby disqualifying HP3 as a good comparison. Accordingly, in this example, the only remaining HP 104 that qualifies for comparison is HP7. The offering prices of HP7 are the same as the offering prices of HP1, except for the prices of offering4. The offering4 purchase price of HP1 is $8 while the offering4 purchase price of HP7 is only $6, thereby yielding a lower offering total for HP7 as compared to HP1. In some cases, the offering total may be referred to a price list cost or category price. As mentioned above, the HIP price list module 174 may construct an HIP price list that comprises offering1-offering7 and the HP7 prices for each of offering1-offering7. Accordingly, HP1 may now attempt to negotiate with HOSs 102 to purchase offering1-offering7 at $40 or less rather than $42. In some embodiments, where an HP 104 does not purchase a particular offering purchased by HP1, a price list cost or category price may nonetheless be generated by selectively utilizing HP1's offering purchase price for the specific offering when computing a price list cost or category price of the HP 104 that does not normally purchase the offering.

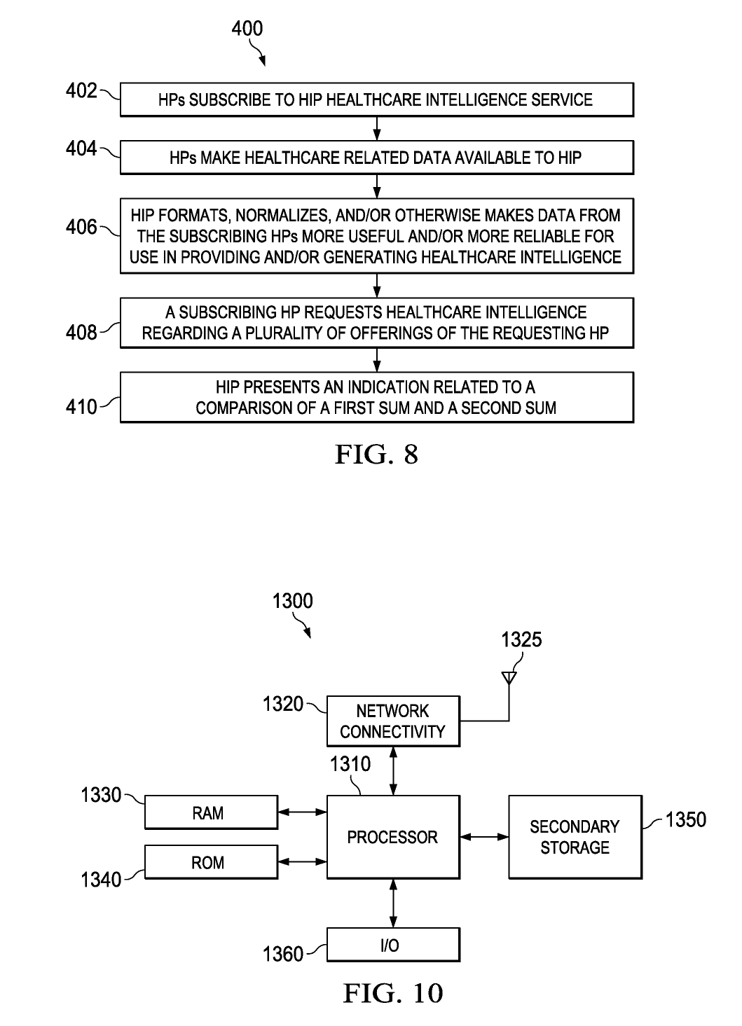

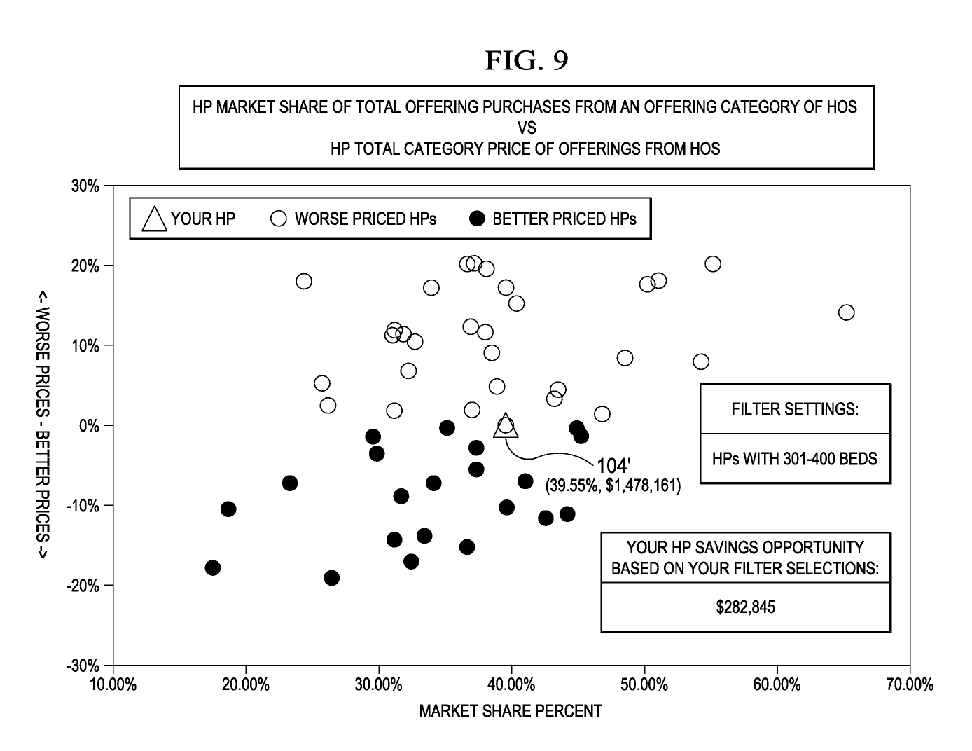

Referring now to FIGS. 8 and 9, a flowchart of a method 400 of generating healthcare intelligence according to another embodiment of the disclosure and an associated chart of illustrative output are shown, respectively. The method 400 may be substantially similar to method 300 so that blocks 402, 404, 406, and 408 are substantially similar to blocks 302, 304, 306, and 308, respectively. However, method 400 may differ from method 300 at least insofar as method 400 may progress to block 410 where the HIP 106 may, more generally, present an indication to an HP 104 related to a comparison of a first sum of offering purchases prices (i.e., a first category price of a first HP and/or a first price list sum of a first HP) and a second sum of offering purchase prices (i.e., a first category price of a second HP and/or a second price list sum of a second HP). In some embodiments, the method 400 may directly present mathematical comparisons in the form of a mathematical difference between a first category price of a first HP and a first category price of a second HP. In other embodiments, the method 400 may graphically or otherwise present data necessary to allow a user to independently ascertain a comparison between the two category prices. In yet other embodiments, HP information may be presented in an ordered manner so that relative location of HP information in a list may indicate relative category prices of the listed HPs.

In some embodiments, a first sum may be associated with a first HP while a second sum may be associated with a second HP. In some cases, the sums may comprise the sums of offering purchase prices paid by each of a first HP and second HP, respectively, for all offerings in a category, all offerings in a category purchased from a particular HOS, all offerings purchased from a particular HOS, and/or any other summation of multiple prices paid for offerings by an HP 104. In other words, method 400 may be configured to provide, present, indicate, and/or enable any comparison between prices paid by a first HP and a second HP for substantially similar categories, sets, types, and/or combinations of substantially similar offerings. In some embodiments, a threshold degree of similarity between categories, offerings, HOSs, and/or HPs may be utilized to selectively limit what comparison related indications are provided, presented, and/or enabled.

Referring now to FIG. 9, a chart illustrating an embodiment of indication output of method 400 is shown. FIG. 9 comprises a scatterplot of a plurality of HPs 104. Particularly, the scatterplot is configured to provide indication of a comparison of offering price sums associated with the first HP 104′ relative to the offering price sums associated with the other HPs 104. In this embodiment, the scatterplot indicates HP market share of total offering purchases from an offering category of an HOS 102 versus HP total category price of offerings from the HOS 102. In other words, this scatterplot indicates relatively what percent of total industry HP spending in a particular category of an HOS 102 each HP 104 accounts for versus the total offering category price of offerings purchased from the HOS 102 (i.e., price list cost) of the HP 104. In some embodiments, simply by viewing the relative location of HP 104′ as compared to the other HPs 104, a user may ascertain that other similarly situated (insofar as market share spending) HPs 104 have paid relatively more or less for the same category of offerings. In some embodiments, the method 400 may further present comparison filters that allow a user to selectively limit which of the other HPs 104 are indicated to the user. For example, a filter setting may limit the indications presented to those associated with HPs of similar number of beds (i.e., a similarly sized hospital and/or a similarly sized hospital system).

In some embodiments, a user may be selectively presented with the data specific to one or more of the HPs 104 being compared so that the user may in turn make better informed market decisions based on the healthcare intelligence obtained by performance of the method 400. In other embodiments, the method 400 may specifically suggest an amount of potential savings the HP 104′ may expect to obtain if the cost of offerings of the comparison are subsequently aligned with those of another HP 104. In some embodiments, the potential savings or savings opportunity may be calculated, selected, presented, and/or indicated as a function of the above-described filter settings.

FIG. 10 illustrates a typical, general-purpose processor (e.g., electronic controller or computer) system 1300 that includes a processing component and/or processor 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, optical disk, or other drive). While only one processor 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information.

The network connectivity devices 1320 might also include one or more transceiver components 1325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1325 might include separate receiving and transmitting units or a single transceiver. Information transmitted or received by the transceiver 1325 may include data that has been processed by the processor 1310 or instructions that are to be executed by processor 1310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs or instructions that are loaded into RAM 1330 when such programs are selected for execution or information is needed.

The I/O devices 1360 may include liquid crystal displays (LCDs), touch screen displays, keyboards, keypads, switches, dials, mice, track balls, voice recognizers, card readers, paper tape readers, printers, video monitors, transducers, sensors, or other well-known input or output devices. Also, the transceiver 1325 might be considered to be a component of the I/O devices 1360 instead of or in addition to being a component of the network connectivity devices 1320. Some or all of the I/O devices 1360 may be substantially similar to various components disclosed herein.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Unless otherwise stated, the term “about” shall mean plus or minus 10 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A method, comprising:
receiving a first set of first category data of a first healthcare provider, the first set of first category data comprising (1) offering identification data associated with a plurality of offerings of the first healthcare provider and (2) offering price data associated with the plurality of offerings of the first healthcare provider;
receiving a second set of first category data of a second healthcare provider, the second set of first category data comprising (1) offering identification data associated with a plurality of offerings of the second healthcare provider and (2) offering price data associated with the plurality of offerings of the second healthcare provider;
comparing the plurality of offerings of the second healthcare provider to the plurality of offerings of the first healthcare provider;
determining whether a predetermined criteria is met regarding whether a sufficient commonality exists between the plurality of offerings of the second healthcare provider and the plurality of offerings of the first healthcare provider; and
when the predetermined criteria is met, presenting at least one of (1) an indication configured to allow a comparison of a first sum of the first offering price associated with the first offering from the first healthcare provider and the first offering price associated with the second offering from the first healthcare provider versus a second sum of the second offering price associated with the first offering from the second healthcare provider and the second offering price associated with the second offering from the second healthcare provider and (2) an indication presented as a result of a comparison of the first sum versus the second sum.

2. The method of claim 1, wherein the predetermined criteria comprises a requirement that the plurality of offerings of the second healthcare provider and the plurality of offerings of the first healthcare provider be offerings of a common offering category.

3. The method of claim 1, wherein the predetermined criteria comprises a requirement that the plurality of offerings of the second healthcare provider and the plurality of offerings of the first healthcare provider be offered by a common healthcare offering supplier.

4. The method of claim 1, wherein the indication configured to allow a comparison comprises a scatterplot.

5. The method of claim 1, wherein the indication configured to allow a comparison comprises an ordered list.

6. The method of claim 1, wherein the indication presented as a result of a comparison comprises a savings opportunity value.

7. The method of claim 1, wherein at least one of the indications is presented as a function of a selection of filter criteria associated with a characteristic of the first healthcare provider.

8. The method of claim 1, further comprising:
when the predetermined criteria is met, generating a third set of first category data comprising at least (1) offering identification data associated with an offering common to each of the first healthcare provider and the second healthcare provider and (2) offering price data of the second set of first category data that is associated with the offering common to each of the first healthcare provider and the second healthcare provider.

9. A method, comprising:
defining a first offering category comprising a first offering and a second offering;
receiving a first offering price associated with the first offering from a first healthcare provider;
receiving a first offering price associated with the second offering from the first healthcare provider;
receiving a second offering price associated with the first offering from a second healthcare provider;
receiving a second offering price associated with the second offering from the second healthcare provider; and
presenting at least one of (1) an indication configured to allow a comparison of a first sum of the first offering price associated with the first offering from the first healthcare provider and the first offering price associated with the second offering from the first healthcare provider versus a second sum of the second offering price associated with the first offering from the second healthcare provider and the second offering price associated with the second offering from the second healthcare provider and (2) an indication presented as a result of a comparison of the first sum versus the second sum.

10. The method of claim 9, wherein the indication configured to allow a comparison comprises a scatterplot.

11. The method of claim 9, wherein the indication configured to allow a comparison comprises an ordered list.

12. The method of claim 9, wherein the indication presented as a result of a comparison comprises a savings opportunity value.

13. The method of claim 9, wherein at least one of the indications is presented as a function of a selection of filter criteria.

14. The method of claim 13, wherein the filter criteria is associated with a healthcare provider characteristic.

15. The method of claim 14, wherein the healthcare provider characteristic comprises a healthcare provider size.

16. The method of claim 9, wherein the healthcare provider comprises a hospital.

17. The method of claim 9, further comprising:
generating a price list comprising (1) at least one of the first offering price associated with the first offering and the second offering price associated with the first offering and (2) at least one of the first offering price associated with the second offering and the second offering price associated with the second offering.

18. A method, comprising:
a first healthcare provider purchasing a first offering for a first offering first price and a second offering for a second offering first price;
a second healthcare provider purchasing the first offering for a first offering second price and the second offering for a second offering second price; and
presenting at least one of (1) an indication configured to allow a comparison of a first sum of the first offering first price and the second offering first price versus a second sum of the first offering second price and the second offering second price and (2) an indication presented as a result of a comparison of the first sum versus the second sum.

19. The method of claim 18:
wherein the first healthcare provider provides the first offering first price and the second offering first price to a healthcare intelligence provider;
wherein the second healthcare provider provides the first offering second price and the second offering second price to the healthcare intelligence provider; and
wherein the healthcare intelligence provider generates the price list.

20. The method of claim 18:
wherein each of the first offering and the second offering comprise at least one of a healthcare related good and a healthcare related service.
